(19) United States
(12) Patent Application Publication
(10) Pub. No.: US 2017/0146776 A1
(43) Pub. Date: May 25, 2017

(54) PHOTOGRAPHIC OPTICAL LENS SYSTEM

(71) Applicant: KOLEN CO., LTD., Gyeonggi-do (KR)

(72) Inventors: Chan Goo Kang, Gyeonggi-do (KR); Jong Jin Lee, Seoul (KR); Seong Hee Bae, Gyeonggi-do (KR)

(21) Appl. No.: 15/348,621

(22) Filed: Nov. 10, 2016

(30) Foreign Application Priority Data
Nov. 20, 2015 (KR) 10-2015-0163344

(51) Int. Cl. G02B 13/00; G02B 9/62

(52) U.S. Cl. CPC G02B 13/0045; G02B 9/62; G02B 5/005

(57) ABSTRACT

Disclosed is a photographic optical lens system. The disclosed optical lens system includes a lens system including a first lens, a second lens, a third lens, a fourth lens, a fifth lens, and a sixth lens which are sequentially disposed on an optic axis between an object and an image plane and each have an incident surface facing the object and an output surface facing the image plane, wherein the first and sixth lenses have positive (+) power, and the second to fifth lenses have negative (−) power.

### CROSS-REFERENCE TO RELATED APPLICATION

This application claims the benefit of Korean Patent Application No. 10-2015-0163344, filed on Nov. 20, 2015, in the Korean Intellectual Property Office, the disclosure of which is incorporated herein in its entirety by reference.

### BACKGROUND

1. Field

One or more embodiments relate to an optical apparatus, and more particularly, to an optical lens system applied to an imaging apparatus.

2. Description of the Related Art

Semiconductor image sensors, which are being developed and improved in various forms, are significantly expanding fields of use of imaging apparatuses, which are generally referred to as cameras.

Charge coupled device (CCD) type semiconductor image sensors and complementary metal oxide semiconductor (CMOS) type semiconductor image sensors are used as typical types of semiconductor image sensors, and recently, as performance of CMOS devices has significantly improved, CMOS devices have been widely applied in their application fields. Since the degree of integration of pixels of such semiconductor image sensors is rapidly increasing with continuous innovation, the semiconductor image sensors are now able to be small and to image images at extremely high resolutions.

A high-quality optical lens system suitable for such image sensors having a large number of pixels is required. A high-quality optical system needs to have few aberrations and high sharpness in all areas.

In order to obtain high-quality images, in addition to the above-described high-quality imaging device, an optical lens system corresponding thereto is required.

An optical lens system applied to a general small-sized camera such as a camera for a mobile phone or vehicle needs to be miniaturized while maintaining high performance. An optical lens system in the related art has a structure in which a plurality of lenses are arranged on a single optic axis, and one or more glass lenses are included in the structure in order to ensure excellent optical performance. Specifically, about 5 to 6 glass lenses are applied to a camera for a vehicle. However, since glass lenses have a high manufacturing cost and constraints on molding or processing, there is a limit to miniaturization of such an optical lens system.

Research on lenses for small-sized cameras that have higher optical performance than that required in optical design, may be easy to miniaturize due to easy molding and processing, and may lower manufacturing costs thereof remains a challenge. Further, since optical lens systems for small-sized cameras, are wide-angle optical lens systems having a wide-field of view, they are suitable for long-distance scenery, group pictures, or the like, but are unsuitable for portraits due to severe image distortion for subjects at near distances.

### SUMMARY

One or more embodiments include an optical lens system that is easy to miniaturize and has high optical performance.

One or more embodiments include an optical lens system of which a manufacturing cost may be lowered while maintaining high optical performance.

One or more embodiments include an optical lens system that is small and may have a narrow-field of view like a normal or telephoto lens, and thus is suitable for portraits.

Additional aspects will be set forth in part in the description which follows and, in part, will be apparent from the description, or may be learned by practice of the presented embodiments.

According to one or more embodiments, an optical lens system includes a lens system including a first lens, a second lens, a third lens, a fourth lens, a fifth lens, and a sixth lens which are sequentially disposed on an optic axis between an object and an image plane and each have an incident surface facing the object and an output surface facing the image plane, wherein the first and sixth lenses have positive (+) power, the second to fifth lenses have negative (−) power, and a field of view FOV of the optical lens system satisfies the following Conditional Expression 1.

45<FOV<50 <Conditional Expression 1>

In an embodiment, a focal length F1 of the first lens and a focal length F6 of the sixth lens satisfy the following Conditional Expression 2.

0.2<|F1/F6|<10.0 <Conditional Expression 2>

In another embodiment, refractive indexes Ind2, Ind3, and Ind4 of the second, third, and fourth lenses satisfy a condition of the following Conditional Expression 3.

1.5<(Ind2/Ind3)*Ind4<1.8 <Conditional Expression 3>

In still another embodiment, a length TTL of the optical lens system and a diagonal length ImgH of an effective pixel of an image sensor satisfy the following Conditional Expression 4.

2<TTL/ImgH<2.1 <Conditional Expression 4>

In yet another embodiment, the third lens may have an incident surface which is convex toward the object.

In yet another embodiment, the fourth lens may have an output surface which is concave with respect to the image plane.

In yet another embodiment, the fifth lens may have an output surface having one or more inflection points toward the image plane.

In yet another embodiment, the sixth lens may have an output surface which is convex toward the image plane.

In yet another embodiment, the sixth lens may have an incident surface and an output surface which are convex toward the object and the image sensor, respectively.

In yet another embodiment, a stop may be provided between the third lens and the fourth lens.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view illustrating an arrangement of main components of an optical lens system according to a first embodiment of the inventive concept;

FIG. 2 is a cross-sectional view illustrating an arrangement of main components of an optical lens system according to a second embodiment of the inventive concept;

FIG. 3 is a cross-sectional view illustrating an arrangement of main components of an optical lens system according to a third embodiment of the inventive concept;

FIG. 4 is a cross-sectional view illustrating an arrangement of main components of an optical lens system according to a fourth embodiment of the inventive concept;

FIG. 5 shows aberration diagrams illustrating longitudinal spherical aberrations, astigmatic field curvatures, and distortion of the optical lens system according to the first embodiment of the inventive concept;

FIG. 6 shows aberration diagrams illustrating longitudinal spherical aberrations, astigmatic field curvatures, and distortion of the optical lens system according to the second embodiment of the inventive concept;

FIG. 7 shows aberration diagrams illustrating longitudinal spherical aberrations, astigmatic field curvatures, and distortion of the optical lens system according to the third embodiment of the inventive concept; and

FIG. 8 shows aberration diagrams illustrating longitudinal spherical aberrations, astigmatic field curvatures, and distortion of the optical lens system according to the fourth embodiment of the inventive concept.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, optical lens systems according to embodiments of the inventive concept will be described in detail with reference to the accompanying drawings. The same reference number which will be used throughout the detailed description refers to the same (or a similar) component.

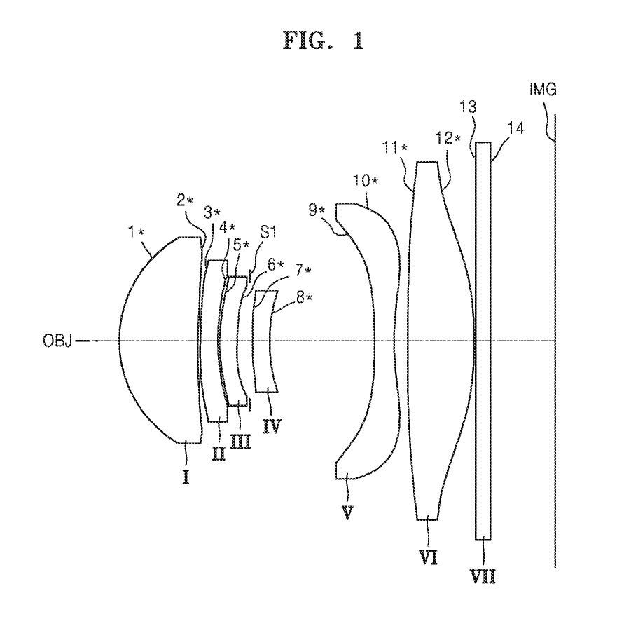

FIGS. 1 to 4 respectively illustrate optical lens systems according to first to fourth embodiments of the inventive concept.

As illustrated in FIGS. 1 to 4, each of the optical lens systems according to the embodiments of the inventive concept includes a lens system of a six-group six-lens constitution having six lenses which are sequentially arranged from the subject OBJ and between a subject (or an object) OBJ and an image sensor IMG having an imaging plane (or an image side) on which an image of the subject OBJ is formed.

A first lens I, a second lens II, a third lens III, a fourth lens IV, a fifth lens V, and a sixth lens VI, which are sequentially arranged between the subject OBJ and the image side IMG, each have an incident surface on which light is incident, that is, an incident surface facing the subject OBJ, and an output surface toward which light is output, that is, an output surface facing the image sensor IMG.

The first lens I has positive (+) power (a refractive index) and an incident surface which is convex toward the subject OBJ.

The second lens II has negative (−) power and is a meniscus lens which is convex toward the subject OBJ.

The third lens III has negative (−) power and is a meniscus lens having an incident surface which is convex toward the subject OBJ.

The fourth lens IV has negative (−) power and is a meniscus lens having an incident surface which is convex toward the subject OBJ.

The fifth lens V has negative (−) power and is a lens having an incident surface and an output surface, which are concave with respect to the subject OBJ and the image side, respectively. Here, the output surface of the fifth lens V may have at least one inflection point.

Meanwhile, the sixth lens VI has positive (+) power and is a biconvex lens having an incident surface and an output surface, which are convex toward the subject OBJ and the image sensor IMG, respectively.

A stop S1 and an infrared (IR) blocking part VII may be further provided. The stop S1 may be provided between the third lens III and the fourth lens IV. The IR blocking part VII may be provided between the sixth lens VI and the image sensor IMG. The IR blocking part VII may be an IR blocking filter. Positions of the stop S1 and the IR blocking part VII may be changed. The optical lens systems according to the embodiments of the inventive concept having the above-described configuration preferably satisfy at least one of the following Conditional Expressions 1 to 4.

45<FOV<50 <Conditional Expression 1>

Here, FOV stands for “field of view” and denotes a diagonal field of view of the optical lens system.

0.2<|F1/F6|<10.0 <Conditional Expression 2>

Here, F1 denotes a focal length of the first lens, and F6 denotes a focal length of the sixth lens.

1.5<(Ind2/Ind3)*Ind4<1.8 <Conditional Expression 3>

Here, Ind2, Ind3, and Ind4 denote refractive indexes of the second, third, and fourth lenses, respectively.

2<TTL/ImgH<2.1 <Conditional Expression 4>

Here, TTL stands for “total track length” and denotes an optic axis length from a center of an incident surface of the first lens to the image sensor, that is, a total length of the optical lens system, and ImgH stands for “image height” and denotes a diagonal length of an effective pixel area of the image sensor.

The above-described Conditional Expression 1 limits the field of view (FOV), and the FOV is limited to being greater than 45 degrees and smaller than 50 degrees. Since a field of view of each of the optical lens systems of the inventive concept ranges from 45 degrees to 50 degrees, it may be seen that the optical lens systems of the inventive concept are included in a normal lens system having a long focus or a telephoto lens system having a focus longer than the normal lens system as an optical lens system for a mobile phone. As a result, since each of the optical lens systems of the inventive concept is small but has a long focus, each of the optical lens systems has a shallower focal depth than an optical lens system in the related art included in a wide-angle optical lens system, and thus it is possible to obtain a high-quality image in which a background is clearly separated from a subject.

Conditional Expression 2 limits a ratio between focal lengths of the first lens and the sixth lens, and serves to increase a resolution and facilitate control of aberrations. That is, Conditional Expression 2 enables an optical lens system with a high resolution and good aberration control to be designed.

Conditional Expression 3 is a condition for manufacturing a second lens and a third lens to be made of plastic. Since a cheap and lightweight lens may be used due to Conditional Expression 3, a manufacturing cost of the optical lens system may be reduced without degradation of image quality.

Conditional Expression 4 limits a ratio between a length and image size of the optical lens system, and a total length of the optical lens system is relatively increased and a field of view thereof is reduced due to Conditional Expression 4. Unlike a wide-angle optical lens system having a short focus in the related art, in the optical lens systems according to the inventive concept, it is possible to implement a telephoto lens system having a long focus or a normal lens system.

In consideration of the fact that a diagonal field of view of a lens having a focal length of 50.00 mm which is a normal lens for a 35 mm camera is 46.79 degrees, it may be seen that the optical lens systems according to the inventive concept are included in at least a normal lens system.

Such optical lens systems of the inventive concept each have a six-group six-lens constitution, negative (−) power is distributed to the second lens, the third lens, the fourth lens, and the fifth lens, and positive (+) power is distributed to the first lens and the sixth lens, which are both ends of each of the optical lens systems. Here, a plurality of aspherical surface inflection points are positioned on an output surface of the sixth lens, and thus various types of aberrations in the aspherical surface are easily corrected. Thus, it is possible to implement an optical lens system suitable for a high-resolution camera system at a relatively low manufacturing cost.

In the above-described first to fourth embodiments of the inventive concept, values in Conditional Expressions 1 to 4 are as illustrated in the following Table 1. In Table 1, units of the field of view 8 are degrees)(°.

TABLE 1

| | | Conditional | | | Conditional | | | | Conditional | | | Conditional |
|---|---|---|---|---|---|---|---|---|---|---|---|---|
| Items | FOV | Expression 1 | F1 | F6 | Expression 2 | Ind 2 | Ind 3 | Ind 4 | Expression 3 | TTL | ImgH | Expression 4 |
| Embodiment 1 | 47.162 | 47.162 | 2.80 | 9.49 | 0.295 | 1.656 | 1.656 | 1.656 | 1.656 | 5.97 | 2.93 | 2.038 |
| Embodiment 2 | 46.821 | 46.821 | 2.82 | 9.95 | 0.283 | 1.656 | 1.656 | 1.656 | 1.656 | 5.98 | 2.93 | 2.041 |
| Embodiment 3 | 47.136 | 47.136 | 2.92 | 10.29 | 0.284 | 1.656 | 1.656 | 1.656 | 1.656 | 5.98 | 2.93 | 2.041 |
| Embodiment 4 | 47.240 | 47.240 | 2.90 | 12.08 | 0.240 | 1.656 | 1.656 | 1.656 | 1.656 | 5.97 | 2.93 | 2.038 |

Referring to Table 1, it may be seen that the optical lens systems in the first to fourth embodiments satisfy Conditional Expressions 1 to 4.

In the optical lens systems according to the embodiments of the inventive concept having such configurations, the first to sixth lenses I to VI may be made of plastic in consideration of shapes and dimensions thereof. That is, all the first to sixth lenses I to VI may be plastic lenses.

While a glass lens makes it difficult to miniaturize an optical lens system due to a high manufacturing cost and constraint conditions for molding or processing, in the present application, since all the first to sixth lenses I to VI may be made of plastic, various advantages may be accordingly achieved.

However, materials of the first to sixth lenses I to VI in the inventive concept are not limited to plastic. At least one of the first to sixth lenses I to VI may be made of glass as necessary, and here, the second lens and the third lens may be made of plastic.

Hereinafter, the first to fourth embodiments of the inventive concept will be described in detail with reference to lens data and the accompanying drawings.

The following Tables 2 to 5 illustrate radiuses of curvature of the lenses I, II, III, IV, V, and VI which are respectively included in the optical lens systems of FIGS. 1 to 4, thicknesses of the lenses, distances between the lenses, refractive indexes, Abbe's numbers, and the like.

In Tables 2 to 5, R denotes a radius of curvature, D denotes a thickness of a lens, a distance between lenses, or a distance between adjacent components, Nd denotes a refractive index of a lens measured using a d-line, and Vd denotes an Abbe's number of a lens with respect to a d-line. A mark * after a lens surface number S indicates that the corresponding lens surface is an aspherical surface. Units of values of R and D are mm.

In Tables 2 to 5, all F numbers of the optical lens systems in the first to fourth embodiments are 2.8, and focal lengths (f) are 6.8 mm, 6.85 mm, 6.8 mm, and 6.8 mm in the order of the embodiments.

TABLE 2

| # | S | R | T | Nd | Vd |
|---|---|---|---|---|---|
| I | 1* | 1.5556 | 1.0789 | 1.546 | 56.093 |
| | 2* | −66.1208 | 0.3000 | | |
| II | 3* | 8.6986 | 0.2300 | 1.656 | 21.465 |
| | 4* | 2.6000 | 0.3000 | | |
| III | 5* | 2.6539 | 0.2300 | 1.656 | 21.465 |
| | 6* | 2.4884 | 0.1349 | | |

| | | |
|---|---|---|
| Stop | Infinity | 0.0913 |

| | | | | | |
|---|---|---|---|---|---|
| IV | 8* | 6.7317 | 0.2300 | 1.656 | 21.465 |
| | 9* | 2.6716 | 1.4254 | | |
| V | 10* | −90.4317 | 0.2800 | 1.546 | 56.093 |
| | 11* | 3.4479 | 0.1742 | | |
| VI | 12* | 19.5358 | 0.9052 | 1.619 | 25.592 |
| | 13* | −8.2397 | 0.0200 | | |

| | | |
|---|---|---|
| 14 | Infinity | 0.2100 |
| 15 | Infinity | 0.9010 |
| Image | Infinity | −0.0010 |

TABLE 3

| # | S | R | T | Nd | Vd |
|---|---|---|---|---|---|
| I | 1* | 1.5687 | 1.0082 | 1.546 | 56.093 |
| | 2* | −61.8436 | 0.3000 | | |
| II | 3* | 8.7361 | 0.2200 | 1.656 | 21.465 |
| | 4* | 2.7493 | 0.0450 | | |
| III | 5* | 3.4434 | 0.2200 | 1.656 | 21.465 |
| | 6* | 3.3184 | 0.1165 | | |

| | | |
|---|---|---|
| Stop | Infinity | 0.1738 |

| | | | | | |
|---|---|---|---|---|---|
| IV | 8* | 5.8916 | 0.2200 | 1.656 | 21.465 |
| | 9* | 2.4874 | 1.4652 | | |
| V | 10* | −51.2479 | 0.2500 | 1.546 | 56.093 |
| | 11* | 3.4312 | 0.1895 | | |
| VI | 12* | 21.1091 | 0.9118 | 1.619 | 25.592 |
| | 13* | −8.5400 | 0.0200 | | |

| | | |
|---|---|---|
| 14 | Infinity | 0.2100 |
| 15 | Infinity | 0.9000 |
| Image | Infinity | 0.0000 |

TABLE 4

| # | S | R | T | Nd | Vd |
|---|---|---|---|---|---|
| I | 1* | 1.6043 | 1.0737 | 1.546 | 56.093 |
| | 2* | −172.7206 | 0.0450 | | |
| II | 3* | 13.3603 | 0.2200 | 1.656 | 21.465 |
| | 4* | 4.3962 | 0.0734 | | |
| III | 5* | 7.6727 | 0.2200 | 1.656 | 21.465 |
| | 6* | 4.0219 | 0.0635 | | |

| | | |
|---|---|---|
| Stop | Infinity | 0.3006 |

| | | | | | |
|---|---|---|---|---|---|
| IV | 8* | 17.7258 | 0.2200 | 1.656 | 21.465 |
| | 9* | 4.5494 | 1.3278 | | |
| V | 10* | −6.2946 | 0.2500 | 1.546 | 56.093 |
| | 11* | 5.2053 | 0.2357 | | |
| VI | 12* | 6.2247 | 0.8204 | 1.656 | 21.465 |
| | 13* | 75.9624 | 0.0200 | | |

| | | |
|---|---|---|
| 14 | Infinity | 0.2100 |
| 15 | Infinity | 0.9000 |
| Image | Infinity | 0.0000 |

TABLE 5

| # | S | R | T | Nd | Vd |
|---|---|---|---|---|---|
| I | 1* | 1.6548 | 1.0307 | 1.546 | 56.093 |
| | 2* | −28.3140 | 0.0305 | | |
| II | 3* | −16.3358 | 0.2200 | 1.656 | 21.465 |
| | 4* | 4.2722 | 0.0736 | | |
| III | 5* | 5.6264 | 0.2428 | 1.656 | 21.465 |
| | 6* | 3.7184 | 0.0763 | | |

| | | |
|---|---|---|
| Stop | Infinity | 0.3842 |

| | | | | | |
|---|---|---|---|---|---|
| IV | 8* | −14.8839 | 0.2200 | 1.656 | 21.465 |
| | 9* | 11.9182 | 1.2957 | | |
| V | 10* | −5.8168 | 0.2500 | 1.546 | 56.093 |
| | 11* | 5.4601 | 0.2498 | | |
| VI | 12* | 7.6888 | 0.7662 | 1.656 | 21.465 |
| | 13* | 250.36039 | 0.0200 | | |

| | | |
|---|---|---|
| 14 | Infinity | 0.2100 |
| 15 | Infinity | 0.9001 |
| Image | Infinity | 0.0000 |

Meanwhile, in the optical lens systems according to the first to fourth embodiments of the inventive concept, the aspherical surfaces satisfy the following aspherical surface equation, Equation 1.

$$Z = \frac{{Y}^{2}}{R ( 1 + \sqrt{1 - ( 1 + K ) {Y}^{2} / {R}^{2}}} + {AY}^{4} + {BY}^{6} + {CY}^{8} + {DY}^{10} + {EY}^{12} + {FY}^{14} + {GY}^{16} + {HY}^{18} + {JY}^{20} \qquad < Equation 1 >$$

Here, Z denotes a distance from a vertex of a lens to an optic axis, Y denotes a distance in a direction perpendicular to the optic axis, R denotes a radius of curvature at a vertex of a lens, K denotes a conic constant, and A, B, C, D, E, F, G, H, and J denote aspheric coefficients.

The optical lens systems according to the inventive concept have a six-group six-lens constitution as described above, positive (+) power is applied to the first lens and the sixth lens, and negative (−) power is distributed to the second lens, the third lens, the fourth lens, and the fifth lens between the first lens and the sixth lens. Meanwhile, since one or more inflection points of an aspherical surface are formed on a lens surface of the sixth and final lens, it is possible to optimally correct various types of aberrations to the aspherical surface.

The following Tables 6 to 9 illustrate aspheric coefficients in the optical lens systems according to the first to fourth embodiments respectively corresponding to FIGS. 1 to 4.

TABLE 6

| S | K | A | B | C | D B | E | F | G | H | J |
|---|---|---|---|---|---|---|---|---|---|---|
| 1 | −0.2271 | 0.0041 | 0.0079 | −0.0157 | 0.0271 | −0.0266 | 0.0176 | −0.0090 | 0.0035 | −0.0007 |
| 2 | 0.0000 | −0.0024 | 0.5065 | −1.6503 | 2.7428 | −2.6783 | 1.5705 | −0.5363 | 0.0960 | −0.0067 |
| 3 | 47.7039 | −0.0771 | 0.7593 | −2.3226 | 3.5862 | −2.8305 | 0.7198 | 0.4785 | −0.3762 | 0.0744 |
| 4 | −5.4435 | −0.1763 | 1.6380 | −7.5024 | 20.6367 | −35.9375 | 39.3071 | −25.9932 | 9.4705 | −1.4579 |
| 5 | 1.7668 | −0.1918 | 1.3984 | −7.7024 | 25.9313 | −54.1171 | 70.4709 | −55.6494 | 24.3152 | −4.4986 |
| 6 | 0.0000 | −0.0469 | 0.2749 | −2.0622 | 8.4657 | −6.4282 | −47.5083 | 155.8752 | −190.5151 | 85.7883 |
| 8 | 0.0000 | 0.0072 | −0.1715 | 1.6239 | −9.8692 | 38.6085 | −90.4663 | 122.9443 | −88.8270 | 26.2611 |
| 9 | 0.0000 | 0.0756 | 0.5313 | −9.4553 | 88.6193 | −480.7588 | 1560.1355 | −2977.1500 | 3071.5080 | −1317.7831 |
| 10 | 0.0000 | −0.0876 | −0.0518 | 0.0735 | −0.0522 | 0.0372 | −0.0220 | 0.0077 | −0.0013 | 0.0001 |
| 11 | 0.0000 | −0.1077 | 0.0478 | −0.0330 | 0.0231 | −0.0160 | 0.0079 | −0.0024 | 0.0004 | −0.0000 |
| 12 | 59.5085 | −0.0696 | 0.1175 | −0.0933 | 0.0449 | −0.0143 | 0.0030 | −0.0004 | 0.0000 | −0.0000 |
| 13 | 0.0000 | −0.0826 | 0.0638 | −0.0446 | 0.0254 | −0.0095 | 0.0022 | −0.0003 | 0.0000 | −0.0000 |

TABLE 7

| S | K | A | B | C | D | E | F | G | H | J |
|---|---|---|---|---|---|---|---|---|---|---|
| 1 | −0.2483 | 0.0057 | 0.0008 | 0.0156 | −0.0533 | 0.1014 | −0.1088 | 0.0659 | −0.0208 | 0.0026 |
| 2 | 0.0000 | −0.0068 | 0.5338 | −1.6933 | 2.7224 | −2.4642 | 1.2351 | −0.2933 | 0.0099 | 0.0054 |
| 3 | 51.3730 | −0.0745 | 0.7520 | −2.1902 | 2.9333 | −1.3159 | −1.1591 | 1.7692 | −0.8404 | 0.1427 |
| 4 | −5.8418 | −0.1302 | 1.0564 | −4.1028 | 9.6323 | −14.8862 | 15.0931 | −9.5943 | 3.4520 | −0.5346 |
| 5 | 2.2395 | −0.1679 | 0.9206 | −4.5422 | 15.6019 | −35.0275 | 49.6705 | −42.5712 | 20.0391 | −3.9647 |
| 6 | 0.0000 | −0.0760 | 0.4246 | −2.9773 | 16.2142 | −49.8196 | 89.1853 | −90.2375 | 46.1081 | −8.4407 |
| 8 | 0.0000 | −0.0015 | −0.0883 | 1.6053 | −10.5221 | 39.5264 | −88.1000 | 113.4423 | −77.2254 | 21.4161 |
| 9 | 0.0000 | 0.0843 | −0.0204 | −0.3908 | 10.0460 | −75.6830 | 290.6435 | −615.8092 | 682.7659 | −308.6816 |
| 10 | 0.0000 | −0.0914 | −0.0623 | 0.0579 | −0.0125 | −0.0058 | 0.0079 | −0.0053 | 0.0018 | −0.0002 |
| 11 | 0.0000 | −0.1019 | 0.0363 | −0.0303 | 0.0314 | −0.0301 | 0.0179 | −0.0061 | 0.0011 | −0.0001 |
| 12 | 59.5085 | −0.0676 | 0.1281 | −0.1036 | 0.0481 | −0.0142 | 0.0027 | −0.0003 | 0.0000 | −0.0000 |
| 13 | 0.0000 | −0.0857 | 0.0671 | −0.0468 | 0.0275 | −0.0107 | 0.0026 | −0.0004 | 0.0000 | −0.0000 |

TABLE 8

| S | K | A | B | C | D | E | F | G | H | J |
|---|---|---|---|---|---|---|---|---|---|---|
| 1 | −0.2653 | 0.0040 | 0.0094 | −0.0144 | 0.0089 | 0.0162 | −0.0343 | 0.0263 | −0.0094 | 0.0013 |
| 2 | 0.0000 | 0.0065 | 0.3657 | −1.2854 | 2.1492 | −2.0579 | 1.1809 | −0.4034 | 0.0775 | −0.0068 |
| 3 | 45.0470 | −0.0684 | 0.7282 | −2.4876 | 4.4746 | −4.8454 | 3.3233 | −1.4525 | 0.3842 | −0.0486 |
| 4 | −9.4900 | −0.1682 | 1.2857 | −5.0567 | 12.6340 | −21.3413 | 23.0754 | −14.3829 | 4.2500 | −0.3169 |
| 5 | 8.3626 | −0.1616 | 1.0704 | −4.8661 | 14.9595 | −31.5243 | 42.4700 | −33.8412 | 14.1912 | −2.3381 |
| 6 | 0.0000 | −0.0863 | 0.5664 | −4.5931 | 22.5354 | −69.0625 | 130.6438 | −147.1644 | 90.2293 | −23.1364 |
| 8 | 0.0000 | 0.0246 | −0.6585 | 7.1909 | −53.5185 | 236.3286 | −634.7237 | 1015.6904 | −888.7302 | 326.7823 |
| 9 | 0.0000 | 0.1387 | −0.7005 | 6.6194 | −40.3131 | 151.6711 | −357.1402 | 513.7915 | −413.3226 | 142.5933 |
| 10 | 0.0000 | 0.0889 | −0.2929 | 0.3592 | −0.2611 | 0.1278 | −0.0426 | 0.0092 | −0.0011 | 0.0001 |
| 11 | 0.0000 | 0.0577 | −0.1751 | 0.1718 | −0.1084 | 0.0467 | −0.0137 | 0.0026 | −0.0003 | 0.0000 |
| 12 | 0.0000 | −0.0809 | 0.1247 | −0.1177 | 0.0700 | −0.0287 | 0.0073 | −0.0012 | 0.0001 | −0.0000 |
| 13 | 0.0000 | −0.1001 | 0.0731 | −0.0381 | 0.0153 | −0.0049 | 0.0012 | −0.0002 | 0.0000 | −0.0000 |

TABLE 9

| S | K | A | B | C | D | E | F | G | H | J |
|---|---|---|---|---|---|---|---|---|---|---|
| 1 | −0.2973 | 0.0038 | 0.0092 | −0.0194 | 0.0252 | −0.0112 | −0.0088 | 0.0130 | −0.0058 | 0.0009 |
| 2 | 0.0000 | −0.0023 | 0.4620 | −1.7023 | 3.1015 | −3.3444 | 2.2488 | −0.9405 | 0.2279 | −0.0248 |
| 3 | −10.2222 | −0.0702 | 0.7179 | −2.4152 | 4.2246 | −4.3680 | 2.7591 | −1.0493 | 0.2248 | −0.0219 |
| 4 | −7.4408 | −0.1357 | 0.9256 | −3.0450 | 6.7054 | −11.4440 | 14.3295 | −11.6004 | 5.3257 | −1.0577 |
| 5 | 13.5746 | −0.1356 | 0.7245 | −2.5404 | 6.5959 | −13.4404 | 18.9203 | −16.1455 | 7.4363 | −1.4236 |
| 6 | 0.0000 | −0.0923 | 0.4583 | −3.2937 | 15.2532 | −44.7681 | 81.5786 | −88.7400 | 52.6457 | −13.1011 |
| 8 | 0.0000 | 0.0242 | −0.3059 | 3.8278 | −31.0764 | 144.8495 | −404.7065 | 666.3463 | −594.8701 | 221.7111 |
| 9 | 0.0000 | 0.1433 | −0.4954 | 5.0626 | −30.8326 | 116.1052 | −274.7254 | 397.3284 | −320.7161 | 110.6587 |
| 10 | 0.0000 | 0.0909 | −0.2905 | 0.3428 | −0.2335 | 0.1050 | −0.0319 | 0.0063 | −0.0007 | 0.0000 |
| 11 | 0.0000 | 0.0598 | −0.1749 | 0.1716 | −0.1084 | 0.0467 | −0.0137 | 0.0026 | −0.0003 | 0.0000 |
| 12 | 0.0000 | −0.0894 | 0.1376 | −0.1283 | 0.0767 | −0.0310 | 0.0084 | −0.0014 | 0.0001 | −0.0000 |
| 13 | 0.0000 | −0.1092 | 0.0840 | −0.0490 | 0.0222 | −0.0076 | 0.0018 | −0.0003 | 0.0000 | −0.0000 |

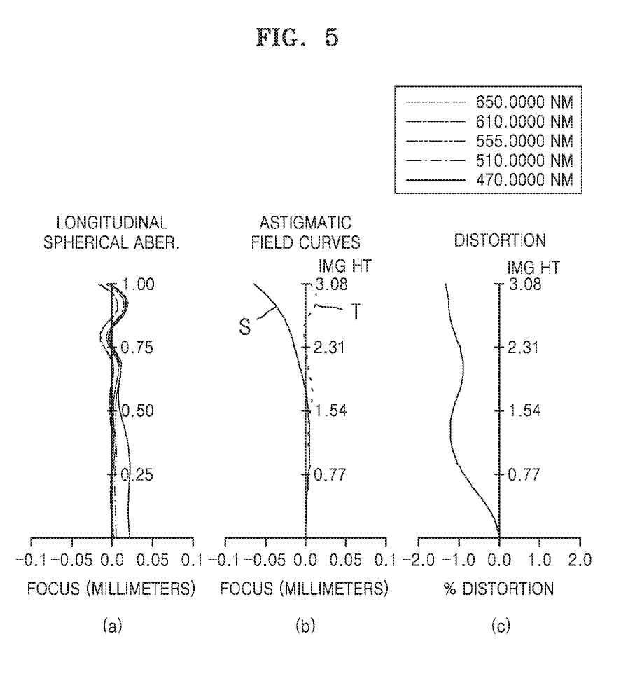

FIG. 5 shows aberration diagrams illustrating longitudinal spherical aberrations, astigmatic field curvatures, and distortion of the optical lens system according to the first embodiment of the inventive concept of FIG. 1, that is, an optical lens system having values of Table 2.

(a) of FIG. 5 illustrates longitudinal spherical aberrations of the optical lens system with respect to light having various wavelengths, and (b) of FIG. 5 illustrates astigmatic field curvatures of the optical lens system, that is, a tangential field curvature T and a sagittal field curvature S.

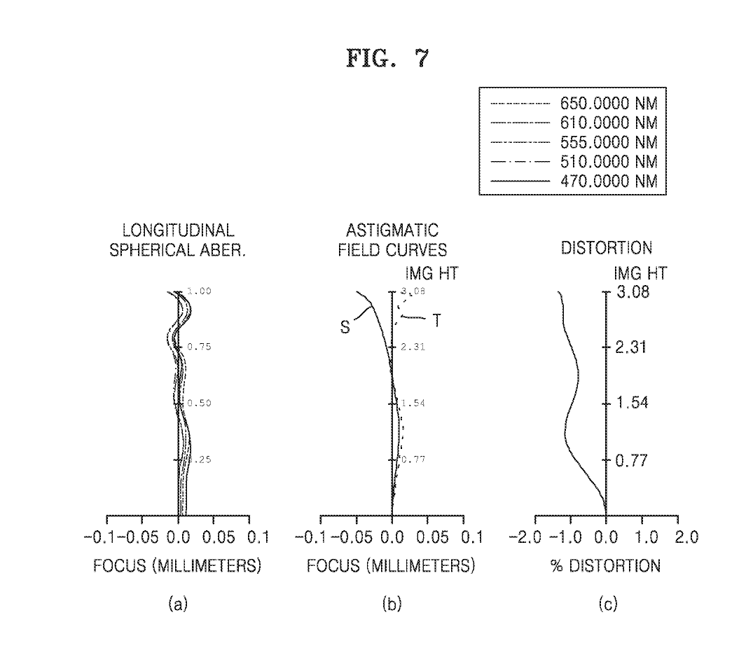

Here, wavelengths of light used for obtaining data in (a) of FIG. 5 are 650.0000 nm, 610.0000 nm, 555.0000 nm, 510.0000 nm, and 470.0000 nm. A wavelength of light used for obtaining data in (b) and (c) thereof is 555.0000 nm. Wavelengths of light in FIGS. 7 to 10 are the same as the above-described wavelengths.

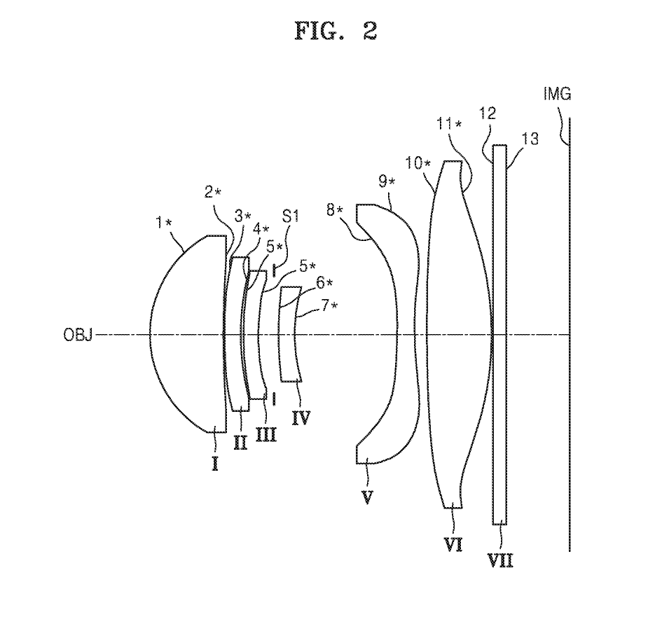

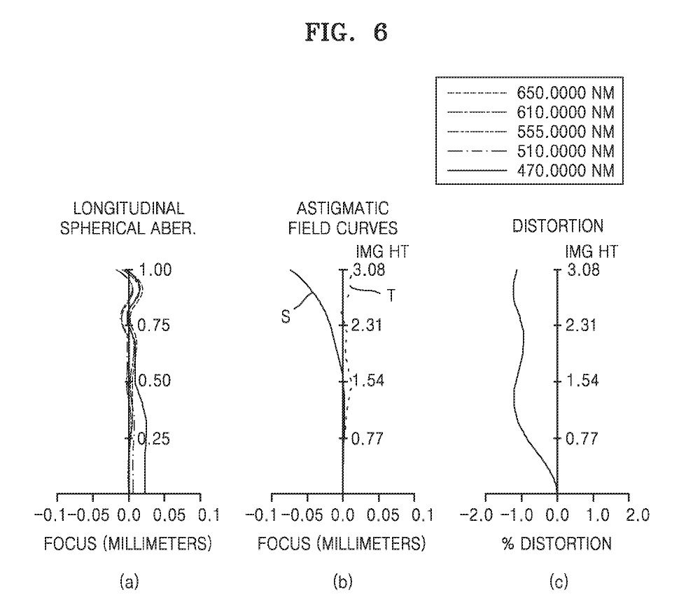

(a), (b), and (c) of FIG. 6 are aberration diagrams respectively illustrating longitudinal spherical aberrations, astigmatic field curvatures, and distortion of the optical lens system according to the second embodiment of the inventive concept of FIG. 2, that is, an optical lens system having values of Table 3.

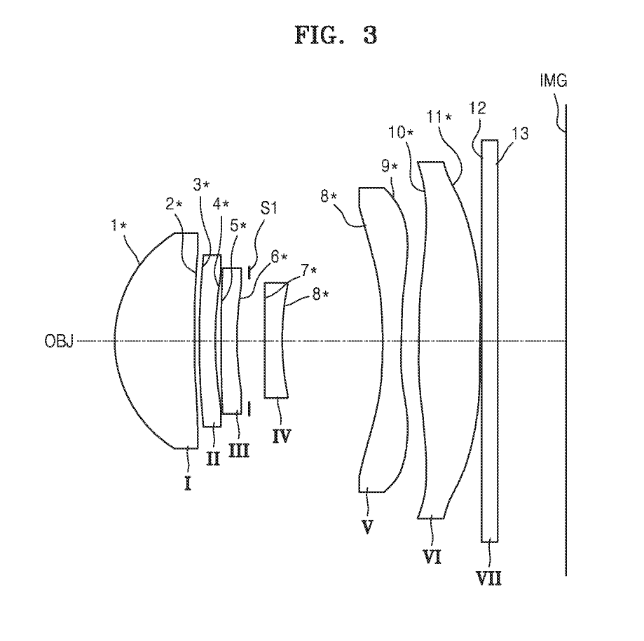

(a), (b), and (c) of FIG. 7 are aberration diagrams respectively illustrating longitudinal spherical aberrations, astigmatic field curvatures, and distortion of the optical lens system according to the third embodiment of the inventive concept of FIG. 3, that is, an optical lens system having values of Table 4.

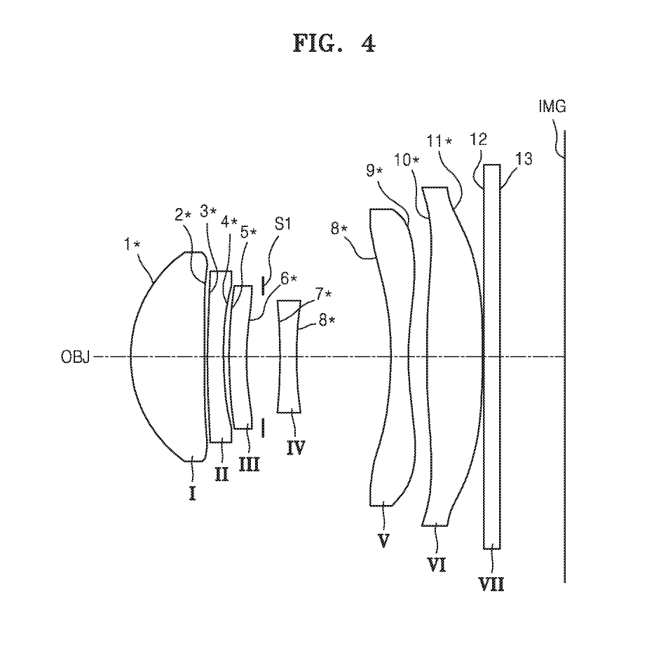

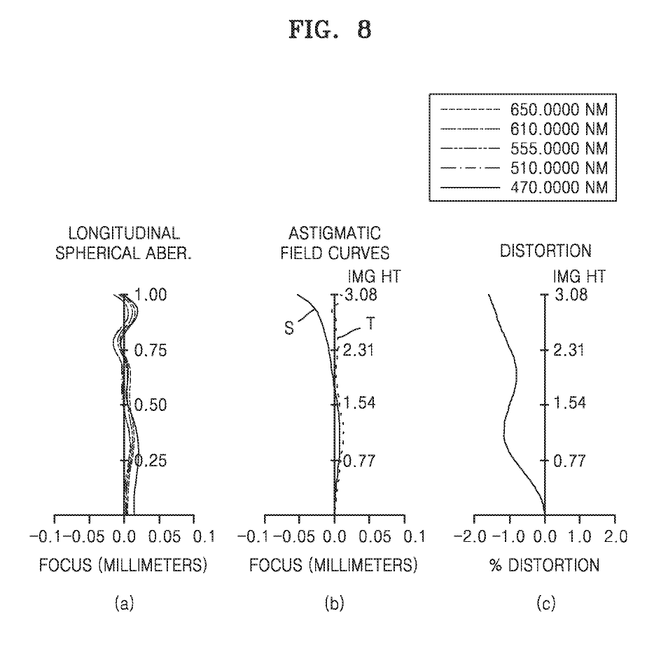

(a), (b), and (c) of FIG. 8 are aberration diagrams respectively illustrating longitudinal spherical aberrations, astigmatic field curvatures, and distortion of the optical lens system according to the fourth embodiment of the inventive concept of FIG. 4, that is, an optical lens system having values of Table 5.

As described above, each of the optical lens systems according to the embodiments of the inventive concept may include the first to sixth lenses I to VI respectively having negative (−) power, positive (+) power, positive (+) power, positive (+) power, negative (−) power, and positive (+) power, which are sequentially arranged from the subject OBJ toward the image sensor IMG, and may satisfy at least one of the above-described Conditional Expressions 1 to 4. Such optical lens systems may easily (optimally) correct various types of aberrations, and have a relatively short total length. Therefore, according to the embodiments of the inventive concept, an optical lens system that is small and may obtain high performance and high resolution may be implemented.

Meanwhile, the first to sixth lenses I to VI are made of plastic and at least one of the incident surface and the output surface of at least the sixth lens of these lenses is configured as an aspherical surface, and thus may implement an optical lens system that is more compact and has better performance at a lower cost than an optical lens system using a glass lens. Further, the optical lens systems according to the inventive concept have a relatively long total length and a narrow field of view, and thus a normal lens system or a telephoto lens system, which may not be implemented in a small-size camera such as a small camera for a mobile phone or the like, may be implemented.

Further, according to another embodiment of the inventive concept, when at least one of an incident surface 14* and an output surface 15* of the fifth lens V is an aspherical surface having at least one inflection point from a center portion toward an edge, various types of aberrations may be easily corrected, and vignetting due to image jamming at diagonal corner portions may be prevented by reducing an output angle of a chief ray.

As described above, according to the inventive concept, an optical lens system that is small and may obtain high performance and high resolution may be implemented. More specifically, each of the optical lens systems according to the embodiments of the inventive concept may include the first to the sixth lenses I to VI having positive (+) power, negative (−) power, negative (−) power, negative (−) power, negative (−) power, and positive (+) power, which are sequentially arranged from the subject OBJ toward the image sensor IMG, and may satisfy at least one of the above-described Conditional Expressions 1 to 4.

Such optical lens systems may implement a normal lens system or a telephoto lens system having various types of aberrations that may be optimally corrected, a relatively long total length, and a narrow field of view, and thus a normal lens or a telephoto lens, which is small and has a converted focal length of around 50 mm or 50 mm or more, may be implemented to enable high-performance image capturing.

Further, the second lens and the third lens may be made of plastic and aberrations may be easily controlled.

While many details have been described in the above description, these will be construed as exemplary embodiments rather than limiting the scope of the inventive concept. For example, it will be understood by those skilled in the art that various additional elements in addition to a filter may be used as an IR blocking part. In addition, it may be understood by those skilled in the art that the embodiments may be variously modified. Therefore, the technical scope of the inventive concept is not defined by the described embodiments, but will be defined by the scope of the appended claims.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. An optical lens system comprising a lens system including a first lens, a second lens, a third lens, a fourth lens, a fifth lens, and a sixth lens which are sequentially disposed on an optic axis between an object and an image plane and each have an incident surface facing the object and an output surface facing the image plane,
wherein:
the first and sixth lenses have positive (+) power;
the second to fifth lenses have negative (−) power; and
a field of view FOV of the optical lens system satisfies the following Conditional Expression 1:
45<FOV<50 <Conditional Expression 1>.

2. The system of claim 1, wherein a focal length F1 of the first lens and a focal length F6 of the sixth lens satisfy the following Conditional Expression 2:
0.2<|F1/F6|<10.0 <Conditional Expression 2>.

3. The system of claim 2, wherein refractive indexes Ind2, Ind3, and Ind4 of the second, third, and fourth lenses satisfy a condition of the following Conditional Expression 3:
1.5<(Ind2/Ind3)*Ind4<1.8 <Conditional Expression 3>.

4. The system of claim 1, wherein refractive indexes Ind2, Ind3, and Ind4 of the second, third, and fourth lenses satisfy a condition of the following Conditional Expression 3:
1.5<(Ind2/Ind3)*Ind4<1.8 <Conditional Expression 3>.

5. The system of claim 3, wherein a length TTL of the optical lens system and a diagonal length ImgH of an effective pixel of an image sensor satisfy the following Conditional Expression 4:
2<TTL/ImgH<2.1 <Conditional Expression 4>.

6. The system of claim 1, wherein a length TTL of the optical lens system and a diagonal length ImgH of an effective pixel of an image sensor satisfy the following Conditional Expression 4:
2<TTL/ImgH<2.1 <Conditional Expression 4>.

7. The system of claim 1, further comprising a stop provided between the third lens and the fourth lens.

8. An optical lens system comprising a lens system including a first lens, a second lens, a third lens, a fourth lens, a fifth lens, and a sixth lens which are sequentially disposed on an optic axis between an object and an image plane and each have an incident surface facing the object and an output surface facing the image plane,
wherein:
the first and sixth lenses have positive (+) power;
the second to fifth lenses have negative (−) power;
the third lens has an incident surface which is convex toward the object;
the fourth lens has an output surface which is concave with respect to the image plane;
the fifth lens has an output surface having one or more inflection points;
the sixth lens has an output surface which is convex toward the image plane; and
the optical lens system satisfies at least one of the following Conditional Expressions 1 to 4:
45<FOV<50 <Conditional Expression 1>
where FOV denotes a field of view of the optical lens system,
0.2<|F1/F6|<10.0 <Conditional Expression 2>
where F1 denotes a focal length of the first lens and F6 denotes a focal length of the sixth lens,
1.5<(Ind2/Ind3)*Ind4<1.8 <Conditional Expression 3>
where Ind2, Ind3, and Ind4 respectively denote refractive indexes of the second, third, and fourth lenses, and
2<TTL/ImgH<2.1 <Conditional Expression 4>
where TTL denotes a length of the optical lens system and ImgH denotes a diagonal length of an effective pixel of an image sensor.

9. The system of claim 8, further comprising a stop provided between the third lens and the fourth lens.

10. The system of claim 9, further comprising a stop provided between the second lens and the third lens.

11. The system of claim 8, wherein the second lens and the third lens are made of plastic.
